(19) United States
(12) Patent Application Publication
(10) Pub. No.: US 2007/0121548 A1
(43) Pub. Date: May 31, 2007

(54) Network generating system and method

(76) Inventors: William J. Manis, Upton, KY (US); William C. Lobe, Brandenburg, KY (US)

Correspondence Address: MIDDLETON & REUTLINGER, 2500 BROWN & WILLIAMSON TOWER, LOUISVILLE, KY, 40202, US

(21) Appl. No.: 11/552,712

(22) Filed: Oct. 25, 2006

Related U.S. Application Data
(60) Provisional application No. 60/730,064, filed on Oct. 25, 2005.

(51) Int. Cl. H04Q 7/00

(52) U.S. Cl. 370/330

(57) ABSTRACT

A wireless communications network generating device comprises an antenna for transmitting and receiving radio frequency signals, a communications bus for routing data signals; a radio frequency transceiver operable to receive incoming signals from said antenna and supply outgoing signals thereto. The signal processor includes a port electrically connected to the communications bus for receiving data signals. The device further comprises an Ethernet controller having a first port connected to said bus for transmitting and receiving data thereon and a second port for transmitting and receiving data to and from a peripheral device; and a microprocessor for processing said data.

### CROSS-REFERENCE TO RELATED APPLICATION

This application claims priority to and benefit from U.S. application Ser. No. 60/730,064, filed on Oct. 25, 2005 under §119(e).

### BACKGROUND OF THE INVENTION

1.Field of the Invention

The present invention relates generally to a system and method of generating a communications network and more specifically to a device or a plurality thereof that may be employed in combination to connect network hosts together to act as a cable, fiber or wire line communications network replacement.

2.Description of the Related Art

Wireless data communications networks are well known in the art, cellular phones being a prime example of such systems. Recent advances in radio frequency transceiver integrated circuitry and antennae which can be printed directly onto circuit boards have made very compact wireless communications devices relatively inexpensive to manufacture and as such, readily available to the public.

Furthermore, wireless Internet transmission technologies have proliferated as wireless local area networks (WLANs) have become more reliable and available in many urban centers. Typically, WLANs are implemented having an Internet connected port, typically a DSL line or DIA circuit, then have various clients connect to the WLAN at an access point, commonly known as a “hot spot”. The client is free to move within apredetermined localized range of the hot spot without interruption in Internet communications. In exemplary WLAN systems, the access point is coupled to a bridging device or wireless router that is in turn connected to a base station that serves as a Network Operations Center for Internet connection.

Other types of wireless communications networks include systems wherein wireless devices communicate point-to-point with each other. In this methodology, wireless devices transmit and receive from device-to-device (or structure-to-structure), thereby creating a mesh or matrix of communications nodes used to transmit data from one location to another. An example of this type of device is the ubiquitous microwave tower, prevalent across the landscape until replaced in large part by satellite communications systems.

The Internet functions as an enormous communications network by linking a plurality of host computers into a great series of networks that are interconnected by routers via the copper wire or fiber optic telecommunications infrastructure. Additionally, the predominant network communications protocol for modern networks is often Ethernet communications, due to its high speed and low cost data handling capabilities as well as the ease of providing most modern personal computers with Ethernet communications capability through the use of network interface cards (NICs).

There is a need, however, for a wireless Internet communications network that can extend far in excess of localized Wi-Fi hot spots, and that may be economically and robustly created by Internet service providers (ISP's) and client-users alike.

### SUMMARY OF THE INVENTION

The present invention provides a system and method of generating a broadband wireless network by utilizing a plurality of network generating devices to transmit wireless data over a plurality of frequencies to other network generating devices placed within a specified distance. The network generating devices of the invention are capable of operating as host devices, routers, or network bridges depending upon user-supplied configuration inputs. Furthermore, the invention is relatively light and compact in size thereby facilitating its placement in a wide variety of locations throughout, for example, a neighborhood or local area.

The network generating devices of the present invention are further designed to provide a wireless communication system that is capable of both sending and receiving data by employing full-duplex Ethernet communications, utilizing CSMA/CA (carrier-sense multiple access/collision avoidance) to reduce or eliminate data loss due to collisions. The network generating devices of the present invention further incorporate multiple broadcast and receive channels carried over dedicated broadcast and receive antennas to permit the system to transmit and receive data in full duplex mode over multiple frequencies, in contradistinction to known wireless network devices.

A plurality of network generating devices may be placed at various locations, for example on structures in a local area wherein each device has at least one other device located within the transmission range thereof. Where a plurality of devices are located within transmission range of each other, a robust redundant network is provided that includes ample bandwidth for wireless Internet communications.

### BRIEF DESCRIPTION OF THE DRAWING FIGURES

FIG. 1 is a block diagram of a network generating device in accordance with one embodiment of the present invention.

FIG. 2 is a schematic diagram of a network generating device in accordance with one embodiment of the present invention.

FIG. 3 is a system diagram of a single network generating device connected to a host in accordance with one embodiment of the present invention.

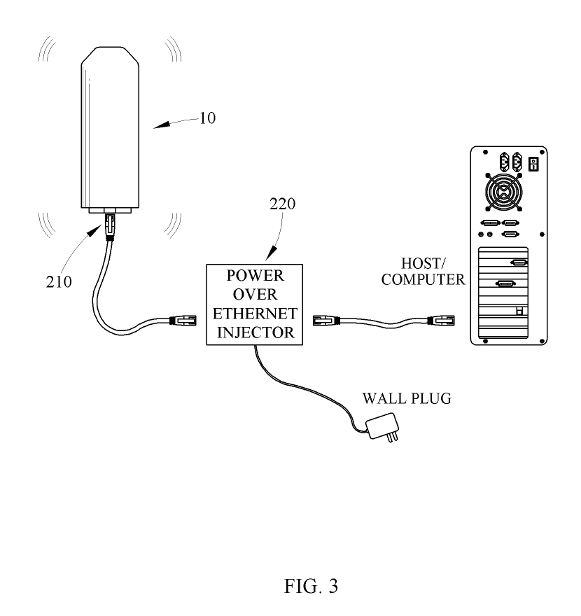

### DETAILED DESCRIPTION OF THE PREFERRED EMBODIMENT(S)

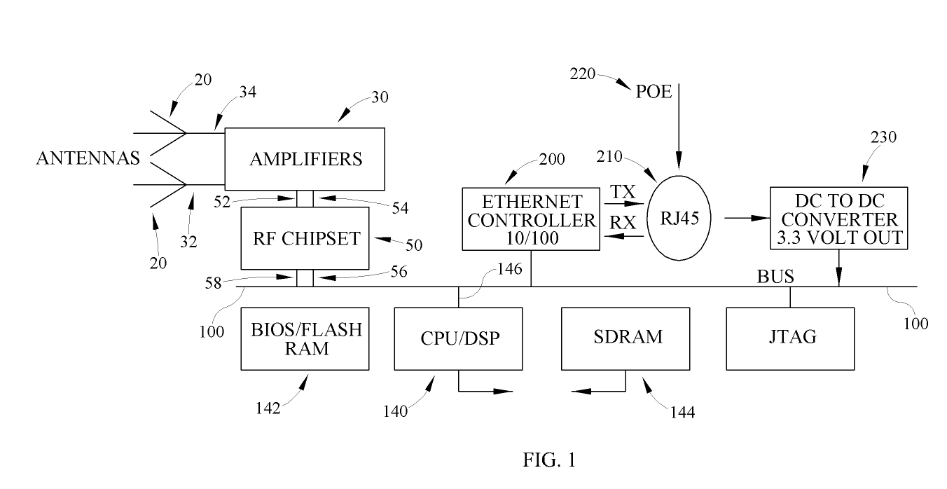

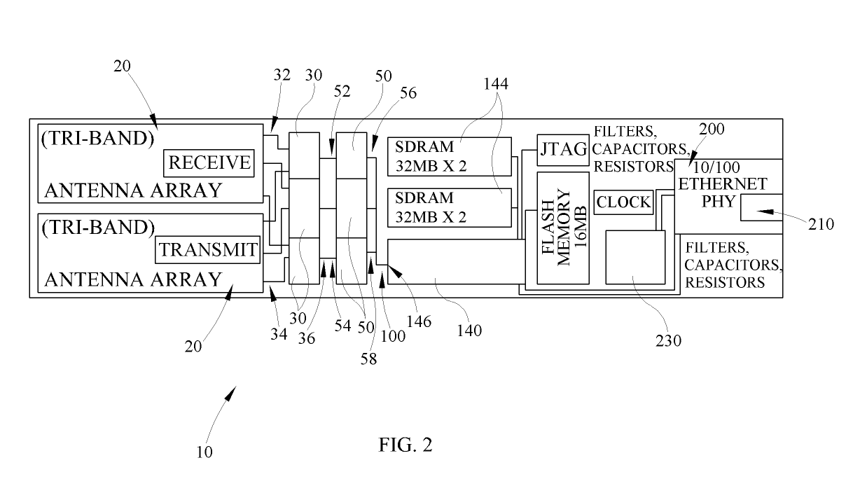

Referring now to FIGS. 1 and 2, and in accordance with a preferred constructed embodiment of the present invention, a wireless network generating device 10 capable of implementing a wireless communications network comprises a plurality of antennas 20 capable of transmitting and receiving radio frequency (RF signals), particularly in the 2.4 GHz to 5.80 GHz range. The antennae 20 of the present invention are preferably capable of being integrated into a conventional printed circuit board as best seen in FIG. 2, thereby providing for an overall device 10 design package that is quite compact and capable of being contained within a weatherproof enclosure or the like. Furthermore, in one embodiment of the present invention at least one antenna 20 is dedicated to receiving data while at least one other antenna 20 is dedicated to transmitting data, thereby enabling the network generating device 10 of the present invention to operate in full duplex mode when transmitting data, as discussed in greater detail below.

Antennae 20 are electrically coupled to at least one amplifier 30 input 32 and/or output 34. Amplifier 30 may operate as a signal conditioner and buffer for data signals transmitted by network generating device 10 as well as increasing the gain of signals supplied to amplifier input 32 for subsequent transmission over antenna 20. Amplifier 30 may be one of many commercially available low-noise radio frequency amplifiers such as, for example a MAX 2649LNA integrated circuit produced and supplied by the Maxim Corporation. In one embodiment of the present invention a plurality of RF amplifiers 30 are electrically coupled to the plurality of antenna 20, wherein each antenna 20 has a dedicated RF signal amplifier 30. This feature of the present invention requires the dedicated receiving antenna 20 be electrically coupled to a buffer input 32 of amplifier 30 and further that dedicated transmit antenna 20 be electrically coupled to a transmit output 34 of amplifier 30, to enable proper signal routing and enable full-duplex communications.

In one embodiment of the invention, the incoming data signal from the dedicated receiving antenna (the data signal being received) is not electrically coupled to amplifier 30, but rather routed directly to an RF transceiver as discussed further herein below. In a yet further embodiment of the invention, amplifier 30 is capable of supplying an output 34 signal to be transmitted through antenna 20 at 950 mW of power, thereby providing sufficient signal strength to enable relative line of sight transmission of signals between network generating devices 10 within a predetermined distance. In one embodiment of the present invention, the device 10 transmits at a signal strength sufficient for the signal to be received by a corresponding device at a range of approximately two miles. One of ordinary skill will recognize that wireless Ethernet communications may be obtained at greater or lesser distances, depending upon various factors such as antenna size, radiating power, interference and geographical signal restrictions.

Network generating device 10 further comprises a radio frequency integrated circuit transceiver 50 having at least one signal input 52 and at least one signal output 54. The input 52 of RF transceiver 50 is electrically coupled to the data signal received through dedicated receiving antenna 20 and may provide signal filtering and noise suppression. The output 54 of RF transceiver 50 is electrically coupled to an amplifier 30 input 36, wherein the RF output signal is amplified prior to transmission. RF transceiver 50 further comprises at least one data output 56 electrically coupled to a data bus 100 and at least one data input 58 electrically coupled to data bus 100 wherein data signals to be transmitted are routed through input 58 from bus 100 while data signals being received are routed to data bus 100 through data output 56.

The RF transceiver 50 may comprise alternative features such as programmable filters, signal gain controls, transmitted signal gain controls, and low power shutdown operation. Exemplary RF transceivers 50 include, but are not limited to a single/dual-band 802.11 integrated circuit transceiver, commercially available from the MAXIM Corporation and capable of operational compliance with 802.11 WLAN (wireless local area network) data communications standards. One of ordinary skill in the art will recognize that a wide variety of commercially available RF transceivers 50 may be employed in conjunction with the present invention, without departing from the scope thereof.

The network generating device 10 further comprises a microprocessor 140 having concomitant associated data memory in the form of flash RAM 142 and/or SDRAM 144. Microprocessor 140 performs the function of a DSP (digital signal processor), conducting routing and gateway operations for the Ethernet network generated by the device 10 of the present invention, including segmentation tasks necessary to Ethernet network communications. Microprocessor 140 includes a port 146 in communication with bus 100 for routing data to and from microprocessor 100 as well as other components of network generating device 10. In one embodiment of the present invention, microprocessor 140 is capable of providing a serial or parallel interface to an Ethernet communications network utilizing IEEE 802.11 or 802.3 communicating protocols. An exemplary microprocessor is an AT76C520 Network Processor available from, for example, the ATMEL® Corporation.

The network generating device 10 of the present invention further comprises an Ethernet controller 200 and associated RJ45 Ethernet jack 210 which enables a peripheral device such as a personal computer or other microprocessor or host capable of communications over an Ethernet communications network to access the network generating device 10 of the present invention. The Ethernet controller 200, for example a 10/100 Base-T PX-5115 available from Mags.com® provides transmit and receive signal isolation as well as one port plug-in access to the network generation device 10.

In a yet further embodiment of the present invention, a power-over-Ethernet injector 220 is employed to provide a direct current power source (DC) of, for example 6 to 12 volts, to the various components of device 10. Furthermore a conventional power transformer 230 may be employed to step down the dc voltage supplied by the power-over-Ethernet injector 220 to a voltage level suitable for powering the integrated circuits required to implement the network generating device 10. In one example power transformer 230 may provide a 3.5 Vdc output to the integrated circuits 30, 50, and 140 employed in the invention 10. An exemplary step-down voltage regulator is produced by National Semi-Conductor under part number LM2676 may be employed to step down an 8 to 40 Vdc input down to a suitable DC supply voltage for integrated circuit applications. This power arrangement permits for cable lengths from the network generating device 10 to a client device near the maximum allowable cable length for Ethernet communications, thereby providing for great flexibility in positioning the devices 10 depending upon customer needs and geographical requirements. In most n suburban neighborhoods, this distance greatly exceeds the distance from the street to most residences.

In operation, the network generating device 10 may be employed in conjunction with like devices 10 as well as one or more host computers to provide for a wireless Ethernet network which may extend indefinitely across free space. The network generating devices 10 communicate with each other via the wireless Ethernet network generated by each operating device, and are coupled to their host devices by wire, namely an Ethernet cable. Furthermore, the invention provides for a plurality of operational modes wherein each device 10 in a given network arrangement is configurable to operate as a wireless bridge, a wireless repeater and a wireless router. In the present invention, each device 10 forms a two-port node of a wireless network, each node having a wireless port and a wired port, where necessary, and, wherein a plurality of devices 10 may be interconnected to form a robust and wide-reaching wireless network over a virtually unlimited geographical area.

When a network generating device 10 is initially powered-up, it is programmed to transmit an RF addressing query over its wireless interface requesting the addresses of other nodes on the network. It also identifies itself as an extension of the network to all nodes detected in the initial query. Upon detection of another network generation device 10, the new device requests an IP (Internet protocol) address and a gateway address. The contacted device 10, if connected to an Internet gateway or a Dynamic Host Configuration Protocol (DHCP) server, supplies the requested information to the requesting node. If the contacted device is not connected to an Internet gateway or a DHCP, the contacted device simply acts as a wireless repeater, routing the request to a gateway or DHCP node.

If the initial addressing query fails to achieve network connectivity over the device 10 wireless port (antenna 20), the same address query is repeated over the device's wired port (Ethernet jack 230). Once these queries are conducted, each device 10 then requests routing tables from all detected nodes, generates a new routing table that includes itself, and broadcasts the new routing tables to its neighboring nodes, thereby including itself in the network. Finally, the device connects itself to its wired client, thereby functioning as either a host gateway, router, repeater or bridge as required for that specific node.

As can be readily seen, the presence of a plurality of network generating devices 10, located at distances from each other sufficient to permit wireless Ethernet communications between adjacent devices, creates a wireless Ethernet infrastructure that is capable of acting as a wire line replacement. This system is particularly suitable for use in regions where wire line service is not readily available, or in urban locations where adding wire line communications functionality may be prohibitively expensive.

The network generating device 10 is capable of functioning as a router for its location in the overall network. Furthermore, the device utilizes carrier sense multiple access/collision avoidance (CSMA/CA) communications protocol, thereby enabling full duplex communications wherein data collision between Ethernet segments is nearly eliminated. Additionally, since the network generating device 10 employs dedicated transmit and receive antennae 20, utilizing multiple broadcast frequencies, the system generated by the interconnection of a plurality of devices 10 is capable of both transmission and reception in full-duplex over multiple frequencies. Accordingly, the network created by the interconnection of a plurality of network generating devices 10 is not plagued by hidden node issues and is more robust as more devices 10 are added to the network.

In a yet further embodiment of the present invention, the network generating device 10 is capable of RF transmission and reception over a plurality of frequency bands. For example, the devices may transmit and receive at 2.45 GHz, 4.9-5.25 GHz, and 5.80 GHz. If transmission between neighboring nodes becomes garbled due to interference from external sources on one of the three operational frequencies, the device 10 transmits an outgoing signal at all three frequency ranges simultaneously, and receives incoming signals at all three frequency ranges simultaneously. This feature of the invention enables clear and error free data communications even when one frequency is unavailable or garbled due to electromagnetic interference or the like. In this embodiment of the invention, a plurality of dedicated antennae 20 may be employed, for example one antenna 20 for each operational frequency transmit and receive.

The present invention 10 is capable of production by modern manufacturing techniques wherein all components are located entirely on a single printed circuit board, thereby providing for an economical and compact network generating device that may readily be secured within a weatherproof enclosure 250, that may further include a fastener or brackets necessary for mounting.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A wireless communications network generating device comprising:
an antenna for transmitting and receiving radio frequency signals;
a communications bus for routing data signals;
a radio frequency signal processor operable to receive incoming signals from said antenna and supply outgoing signals thereto, said signal processor having a port electrically connected to said communications bus for receiving data signals;
an Ethernet controller having a first port connected to said communications bus for transmitting and receiving data thereon and a second port for transmitting and receiving data to and from a peripheral device; and
a microprocessor for processing said data having a data memory and a communications port connected to said bus.

2. A device as claimed in claim 1 further comprising:
a power over Ethernet injector electrically coupled to said Ethernet controller to provide electrical power to said network generating device through said Ethernet controller.

3. A device as claimed in claim 1 wherein said antenna comprises a tri-band antenna.

4. A device as claimed in claim 1 further comprising:
a plurality of antennas for transmitting and receiving radio frequency signals, wherein at least one antenna is operable as a signal receiving antenna and wherein at least one antenna is operable as a signal transmitting antenna.

5. A device as claimed in claim 1 wherein said antenna comprises an antenna array integral to a printed circuit board.

6. A device as claimed in claim 4 wherein said plurality of antennas comprise a plurality of antenna arrays integral to a printed circuit board.

7. A device as claimed in claim 1 wherein said antenna, said communications bus, said radio frequency transceiver, said Ethernet controller and said microprocessor are disposed on a printed circuit board.

8. A device as claimed in claim 4 wherein said radio frequency signals are transmitted and received in full duplex mode.

9. A device as claimed in claim 1 wherein said antenna broadcasts at a plurality of broadcast frequencies.

10. A device as claimed in claim 4 wherein said transmitting and receiving antennas are operable at a plurality of broadcast frequencies.

11. A device as claimed in claim 9 wherein said broadcast frequencies are 2.45, 4.9 to 5.25 and 5.80 gigahertz.

12. A device as claimed in claim 10 wherein said broadcast frequencies are 2.45, 4.9 to 5.25 and 5.80 gigahertz.

13. A wireless communications network comprising:
a plurality of wireless network generating devices disposed within a predetermined distance of each other wherein a portion of said network generating devices are operable as wireless routers.

14. A wireless communications network as claimed in claim 13 wherein each of said plurality of wireless network generating devices is within signal broadcast range of at least two of said plurality of network generating devices.

15. A wireless communications network as claimed in claim 13 wherein a plurality of said network generating devices are operable as repeaters and bridges for local area networks.

16. A wireless broadband communications network comprising:
a plurality of wireless network generating devices comprising;
an antenna for transmitting radio frequency signals;
an antenna for receiving radio frequency signals;
a communications bus for routing data signals;
a radio frequency transceiver operable to receive incoming signals from said receiving antenna and supply outgoing signals to said transmitting antenna, said signal processor having a port electrically connected to said communications bus for receiving data signals;
an Ethernet controller having a first port connected to said bus for transmitting and receiving data thereon and a second port for transmitting and receiving data to and from a peripheral device; and
a microprocessor for processing said data having a data memory and a communications port connected to said bus; and
wherein a plurality of said network generating devices are operable as wireless routers.

17. A wireless broadband communications network as claimed in claim 16 wherein each of said plurality of wireless network generating devices is within signal broadcast range of at least two of said plurality of network generating devices.

18. A wireless broadband and communications network as claimed in claim 16 wherein said plurality of wireless network generating devices further comprise:
a plurality of antenna arrays integrally provided on an printed circuit board.

19. A wireless broadband communications network as claimed in claim 16 wherein said radio frequency signals are transmitted and received in full duplex mode.

20. A wireless broadband communications network as claimed in claim 16 wherein said antenna broadcasts at a plurality of broadcast frequencies.

21. A wireless broadband communications network as claimed in claim 16 wherein said transmitting and receiving antennas are operable at a plurality of broadcast frequencies.

22. A wireless broadband communications network as claimed in claim 16 wherein said broadcast frequencies are 2.45, 4.9 to 5.25 and 5.80 gigahertz.

23. A wireless broadband communications network as claimed in claim 16 wherein said broadcast frequencies are 2.45, 4.9 to 5.25 and 5.80 gigahertz.

24. A wireless broadband communications network as claimed in claim 16 wherein said antennae of said plurality of wireless network generating devices comprise a tri-band antenna.
